(19) United States
(12) Patent Application Publication
(10) Pub. No.: US 2026/0145288 A1
(43) Pub. Date: May 28, 2026

(54) METHOD FOR POSITIONING A WORKPIECE AND APPARATUS THEREFOR

(71) Applicant: Torsten HERTING, Grindelwald (CH)

(72) Inventor: Torsten HERTING, Grindelwald (CH)

(21) Appl. No.: 19/451,637

(22) Filed: Jan. 16, 2026

Related U.S. Application Data
(62) Division of application No. 17/278,092, now Pat. No. 12,539,572.

(30) Foreign Application Priority Data
Sep. 20, 2018 (EP) 18195720.0

(51) Int. Cl. B23Q 15/12; A61C 13/00; B23Q 3/18

(52) U.S. Cl. CPC B23Q 15/12; A61C 13/0004; B23Q 3/18

(57) ABSTRACT

A method for precisely positioning a dental prosthesis workpiece in a machine tool includes creating an impression on a part positionable with respect to the tool in a known position in the tool, allowing arrangement of the workpiece precisely on the impression. The device includes a blank and a counter on which an impression is formed. The blank and the counter have key structures so they can be separated from each other and reproducibly reconnected in the same arrangement. An alternative on a computational basis is to provide the workpiece with referencing bodies, to determine their positions by scanning the workpiece, machining steps being generated based on the scan, and to scan the workpiece in a tool on a blank provided with key structures whose tool coordinates are known to determine the position of the workpiece in the tool both in terms of tool and construction system coordinates.

### CROSS REFERENCE TO RELATED APPLICATIONS

This application is a Divisional of application Ser. No. 17/278,092, filed on Mar. 19, 2021, which is the National Phase under 35 U.S.C. § 371 of International Application No. PCT/EP2019/075238, filed on Sep. 19, 2019, which claims the benefit under 35 U.S.C. § 119(a) to Patent Application No. 18195720.0, filed in Europe on Sep. 20, 2018, all of which are hereby expressly incorporated by reference into the present application.

### BACKGROUND OF THE INVENTION

### Field of the Invention

The present invention relates to a method for positioning a workpiece. It further relates to a device for positioning a workpiece.

The preferred field of application and the starting point of the present invention is the manufacture and subsequent modification of dental prostheses. However, the invention is applicable to the manufacture generally of workpieces and in particular to their subsequent machining, such as engine parts, car parts, aircraft parts, ship parts, machine parts, model making parts and other parts, tools, etc.

### Description of the Related Art

A dental prosthesis is manufactured in several steps. For example, the prosthesis base is milled first. Then the tooth layer is bonded to the base. To this end, the prosthesis must be removed from the milling machine and thus loses its position. After reattaching, re-referencing is necessary in each case.

According to the state of the art, this is currently possible with mechanical measuring probes, which involve the following problems, among others:
The probe arm or similar must be firmly connected to the machine.
The probe system must be calibrated,
is sensitive to temperature fluctuations,
requires appropriate space in the machine,
is technically complex and
is costly

Existing dental prostheses need to be reworked and adjusted for various reasons. A common reason is a change of the jaw, which requires an adjustment of the dental prosthesis by relining, i.e. filling of resulting cavities between the gingiva and the prosthesis.

Teeth and/or the prosthesis base also need to be modified after the removal of one or more teeth. Retaining elements such as clasps, implant abutments, attachments must be modified and/or incorporated. In the course of its manufacture, a new dental prosthesis must be tried on, test worn, as the case may be, and corrected according to the patient's feedback.

For modifications to dental prostheses, subtractive (grinding, milling) and additive machining processes (3D printing, in particular metal laser melting processes) are being used. In all of these processes, the prosthesis (or a workpiece in general) must be precisely inserted in a defined position in the workpiece holder of the respective machine tool. However, such positioning with the required accuracy (usually in the order of 0.1 mm or better) is very complex and time-consuming. This problem is due to the fact that machine tools perform machining operations according to data originating from construction software (CAM system) or another source while the relationship of the position of the coordinate system of the machine tool and of the coordinate system of the CAM system, the construction coordinate system, relative to each other is unknown.

Regularly an image of the workpiece, e.g. before and after the intended machining, exists in the construction coordinate system, and specifically in this coordinate system the machining steps (tool movements, etc.) are defined. For the actual machining steps, especially in the case of automated, computer-controlled execution, the coordinates of the machining steps must be mapped with correspondingly high precision from the construction coordinate system into the coordinate system resulting from the real position of the workpiece in the machine tool, and this moreover in a coordinate system in which the machine tool performs the machining steps. Thus, another problem is that this mapping also depends on the spatial arrangement of the workpiece in the machine tool.

### SUMMARY OF THE INVENTION

Therefore, it is an object of the present invention to simplify the accurate positioning of a workpiece in a machine tool.

A corresponding method is disclosed, as are preferred embodiments of the method and devices for use in this method.

Both the process and the device take advantage of the fact that it is possible with little effort to produce a duplicate having the shape of the particular workpiece from a low-cost material on the basis of the existing design, i.e. from digital data for controlling a numerically controlled (computer-controlled) machine tool. The duplicate is produced on a base or platform and forms a so-called blank with the latter. An impression of the duplicate is made on a counter piece, the so-called counter. The impression can be limited to selected areas of the duplicate (“reference zones”) which are sufficiently significant overall so that when the duplicate is removed and placed back on the impression, the duplicate or, in a later step, the original of the workpiece reproducibly engages in the same position on the impression. In the case of a dental prosthesis, these defining points can be sufficiently large surface sections of the teeth, i.e. their occlusal surfaces, but also the underside of the prosthesis or its outer surfaces. Of course, if a treatment is intended on the teeth, these are not available for these reference zones. In addition to the reference zones, the duplicate may include any further sections of the workpiece or even the complete workpiece, provided that these additional sections do not interfere with the intended machining steps.

The counter has a positioning section which is preferably located outside the area covered by the workpiece. One or more key structures are arranged in this positioning section. The key structures are designed in such a way that they allow the counter to be precisely mounted in a predetermined position on a base, usually a blank. The counter pieces to the key structures on the counter, the blank key structures, are produced by the respective machine tool. Their position is therefore known by the coordinate system of the machine tool. Thus, the position of the key structures on the counter relative to the impression of the reference of the workpiece, in particular a dental prosthesis, is also known. Overall, it is thus possible to precisely define the position of a workpiece (a dental prosthesis) attached to the blank or also to the impression of the counter, as well as the exact positioning of the counter via the key structures on the blank, relative to the coordinate system of the machine tool. By milling the duplicate, the machine shows in which position it is machining the workpiece. By using the counter, the workpiece is then fixed in exactly that position.

With this knowledge, it is possible to convert the design into tool coordinates, which enables defined machining of the workpiece exactly in the intended locations.

Another way of mapping the coordinate systems of the machine tool, the design (CAM data), and the workpiece to one another is to perform a scan of the workpiece when it is placed in the machine tool on a blank, while reference marks or reference features are previously applied in defined positions on the workpiece and key features (key structures) are applied to the blank. Here, the key structures are always generated by the machine tool so that they correspond to predetermined coordinates of the machine tool. The reference marks on the workpiece make it possible to precisely identify the position of the workpiece in the scan. Alternatively, significant features of the workpiece itself can be used. However, this often leads to a lower precision in the recognition of the position of the workpiece in space and to an increased computational effort. Depending on its realization, the method according to the invention offers at least one of the following advantages and in preferred embodiments even all of these advantages:
It can be performed with mobile intraoral scanners: Such scanners are available in dental practices with digital equipment, thereby offering a financial advantage
Higher precision
Temperature independence
Machine independence
No structural modification of the machine is necessary (financial advantage, among others)
Easier handling

### BRIEF DESCRIPTION OF THE DRAWINGS

The invention is further explained by means of exemplary embodiments with reference to figures showing:

FIG. 1 top view of a dental prosthesis as a prototype of a workpiece;

FIG. 2 view from below of a support plate for a counter (counter piece);

FIG. 3 top view of a blank (base) with a workpiece (dental prosthesis);

FIG. 4 section according to IV-IV in FIG. 3;

FIG. 5 section according to V-V in FIG. 2 and IV-IV in FIG. 3 after forming the workpiece negative (prosthesis impression);

FIG. 6 section as in FIG. 5, with impression lifted from blank;

FIG. 7 lateral view of a reduced prosthesis;

FIG. 8 section through a blank according to VIII-VIII in FIG. 13, with space for prosthesis exposed;

FIG. 9 illustration in analogy to FIG. 6, with real workpiece (dental prosthesis) inserted in holder according to FIG. 8 and counter piece with impression placed thereon;

FIG. 10 top view of dental prosthesis with referencing beads;

FIG. 11 top view of blank platform with key structures;

FIG. 12 virtual blank with workpiece;

FIG. 13 top view of blank with recess for a prosthesis;

FIG. 14 top view of blank according to FIG. 13 with inserted prosthesis, ideal position according to FIG. 12 dashed;

FIG. 15 section according to XV-XV in FIG. 14; and

FIG. 16 top view in analogy to FIG. 14 with indication of reference points (schematized).

### DESCRIPTION OF THE PREFERRED EMBODIMENTS

### First Exemplary Embodiment

According to the first embodiment, a tool is produced which allows a dental prosthesis or generally a workpiece to be arranged in a machine tool in such a way that its position exactly corresponds to an existing, numerical design. The design can be revised for adjustments or modifications, after which the changes are made under numerical control with the aid of a machine tool exactly at the specified locations on the real object.

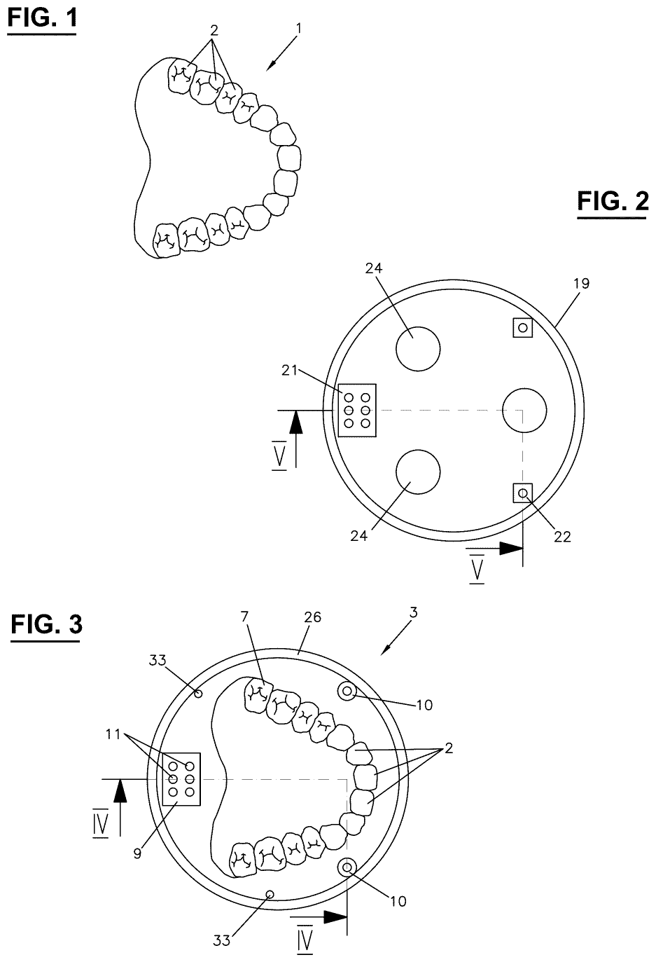

A dental prosthesis 1 with teeth 2 (partially marked with reference numerals) shown by way of an example in FIG. 1 is scanned and recorded in a suitable design program. By means of the design program, the required modifications to the digital image of dental prosthesis 1 can be planned. In a machine tool, a blank 3 is created (additive or subtractive manufacturing). Blank 3 comprises a platform 5 on which a partial copy 7 of dental prosthesis 1 is produced. Only the structures for referencing or for fixing it in the counter are necessary: usually the occlusal surfaces of the prosthetic teeth. Outside the area of dental prosthesis 7, key structures 9 and 10 are also produced by the machine tool that produces duplicate 7. Key structure 9 essentially consists of an arrangement of circular studs 11 (here six studs) similar to known plug-in blocks.

Blank (base) 3 consists of a dimensionally stable material and, in particular, a material that serves as a component of the workpiece after machining. The material may e.g. be pink plastic material, often PMMA or another physiologically acceptable polymer or base material, used as a relining material in dental prostheses. Also conceivable is steel, plastic material, titanium, model casting, especially fiber-reinforced plastic material, and ceramic material. Furthermore, it may comprise the necessary provisions (not shown here), such as grooves, holes, etc., that are needed to mount it in a machine tool, preferably in a precisely defined position.

Obviously, a complementarily formed counter piece can be plugged on, whereby a very precise positioning of the counter piece can be achieved also with respect to rotational movement. The second type of key structure 10 shows an alternative, several (here two) of which are produced on the blank, which individually still permit freedom of movement of an attached, complementarily formed mating key, but as a whole also achieve a precise positioning. Here, circular cylindrical studs 11 are shown, but at least one additional key structure that is spaced from the other one is advantageous to increase positioning accuracy.

Various shapes of key structures 9 and 10 are possible which deviate from those shown. As will be explained below, it is essential that a counter piece placed thereon can be attached in exactly one position and without a possibility of further movement. Instead of circular-cylindrical studs, polygonal shapes or any shapes that deviate from the circular shape, such as elliptical and oval, are obvious. Instead of studs, recesses, i.e. bores, can also be provided, in which case the counter piece must accordingly have correspondingly shaped elevations instead of recesses, or vice versa.

The number of studs is not decisive. Possible are at least 2 (since two studs already prevent not only a displacement but also a rotation), 3, 4, 5, 6, 7, 8 and more studs, or also an irregular configuration which essentially only allows one position relative to a counter piece, however. Also conceivable are studs that do not have a circular cross-section, such as an elliptical, oval, egg-shaped, polygonal one (preferably triangular to hexagonal, in order to still obtain pronounced corners and thus a high resistance to twisting, while higher numbers of corners are conceivable in principle, but form a transition to the properties of a stud having a circular cross-section), and which already prevent twisting about the vertical axis of the stud individually. An arrangement of at least 2 studs is preferable in order to prevent a rotation, and a plurality of studs offers in principle a higher precision of the positioning on a counter piece due to a larger ratio between the effective area of the key structure (stud arrangement) and the total area of the blank or prosthesis, or the maximum diameter (e.g. the distance of the centers [centers of gravity] of the studs arranged furthest apart) of the key structure to the largest diameter of the prosthesis or blank as a whole (here, due to the circular shape: its diameter). Accordingly, the arrangement of more than one key structure, here prototypically of key structure 9 and of simpler key structures 10, also serves to increase this ratio and thus to achieve a more precise positioning.

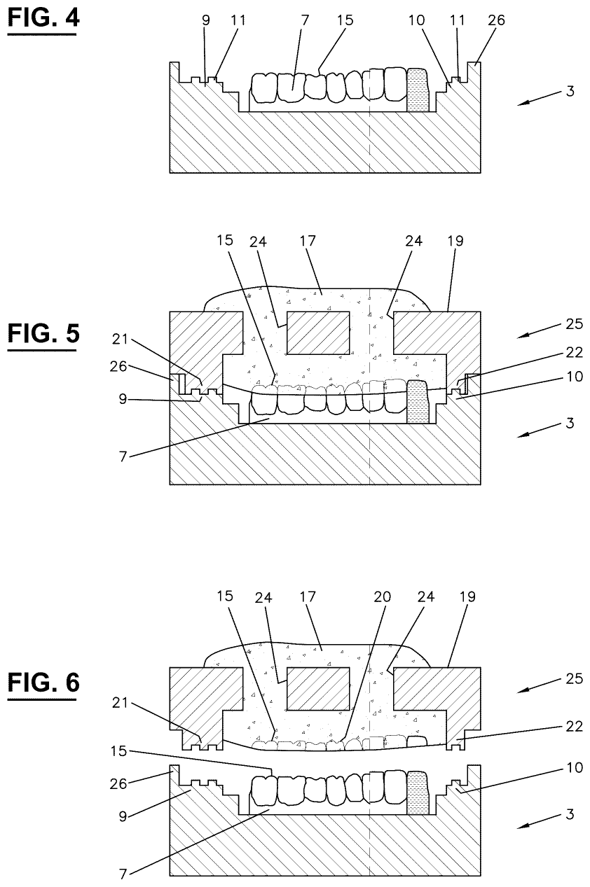

Also, the prosthesis or generally the workpiece does not have to be completely duplicated; on the contrary, it is sufficient to form a sufficiently large number of significant parts so that the original part can be precisely and unambiguously positioned in an impression made of the duplicate. As can be seen in FIG. 4, these can be a sufficiently large number of occlusal surfaces of duplicate 7 or of dental prosthesis 1, in particular. Obviously, those areas which are intended for machining cannot be used.

A suitable casting compound 17 (gypsum; thermoplastic or permanently curable (e.g. by crosslinking) polymer material) and a referencing key holder 19 are applied to blank 3 (see FIG. 5).

Referencing key holder 19 (see FIG. 2) has key structures 21, 22, on one hand, which are complementary to key structures 9, 10 of the blank. Openings 24 serve to anchor the cured impression to reference key holder 19 by means of impression material 17 passing therethrough. After the impression material 17 has cured, a so-called counter 25 or counter piece is created, which essentially consists of reference key holder 19 and the hardened impression material 17 and has on its surface, at least in parts, an exact (negative) image 20 of the surface of the duplicate 7. As shown in FIG. 4, reference key holder 19 abuts against the blank, and particularly key structures 9, 10 or 21, 22 engage in one another, so that counter 25 can be reattached to the blank in exactly the same position. In the figure it is made clear that the distance is determined by the height of rim 26 so that although the key structures must be sufficiently high to engage in one another, they do not determine the distance between blank 3 and reference key holder 19.

It is conceivable, however, that key structures 9, 10 and 21, 22 also define the distance between blank 3 and reference key holder 19, i.e. that they abut against each other. However, rim 26 can then still be present as a circumferential elevation, e.g. to prevent a fixing agent 29 (see below) from leaking out of blank 3.

Regarding the material of the reference key holder, the same considerations apply as those made for blank 3 above.

FIG. 6 shows counter 25 lifted off from blank 3.

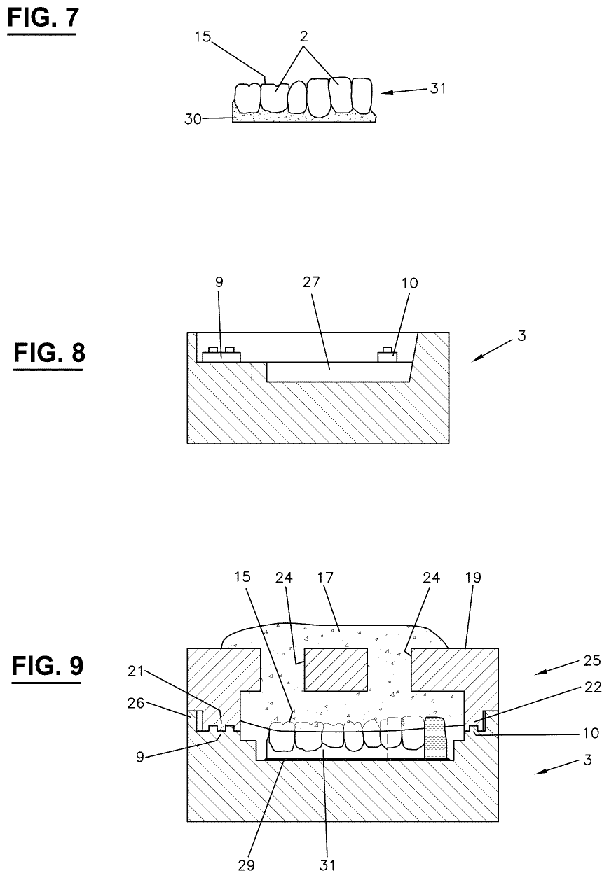

Duplicate 7 is removed so as to obtain a free space 27 for receiving dental prosthesis 1. A flowable material 29 is introduced into free space 27 in a suitable quantity. This material 29 can be a construction material that is used to form a part of prosthesis 1 later on. Another suitable material which is suitable for pressing prosthesis 1 against impression 20 in counter 25 is also conceivable. Here, by way of an example, dental prosthesis 1 is reduced up to teeth 2, as shown in FIG. 7, i.e. all of the relining impression material is removed in any case. The reduced prosthesis, which is milled flat at the bottom, can be fixed to blank 3 by means of an adhesive being used as a fixing agent 29, which itself serves as the material of the dental prosthesis. Blank 3 is also made of an imitation material. Known for this purpose is polymethyl methacrylate that is suitably colored to serve as an imitation gingiva. By attaching counter 25, prosthesis 1 is fixed in the position determined by impression 20 before the fixing agent solidifies and thus fixes the prosthesis to blank 3.

Also, on blank 3, a larger quantity of gingiva imitation material can be filled as a fixing agent 29 into free space 27 in excess and the (reduced) prosthesis 31 is placed on it. Counter 25 is placed thereon, whereby the reduced denture 31 is pressed into fixing agent 29, which then also serves as the raw material for the imitation gingiva on the dental prosthesis.

Fixing material in a larger layer thickness generally serves to press the prosthesis against and even into the impression material, compensating for deviations of the abutting surfaces, and to hold it there until the fixing agent has solidified. Fixing agent 29 is at least viscous to knead-like. Also conceivable is a thixotropic material or another material which loses viscosity or at least liquefies sufficiently under an external influence such as a mechanical load, e.g. vibration or displacement, or when heated or irradiated, and returns to a solid state by itself. Frequently, and especially when the fixing agent forms part of the processed prosthesis, an irreversible hardening or solidification is carried out, e.g. a polymerization or cross-linking. The latter can be achieved by heating, irradiation (electromagnetic radiation such as light, microwaves, X-rays, corpuscular radiation (elementary particles such as electrons) or combinations thereof. Time-controlled curing by delayed activation of an added catalyst for polymerization is also conceivable.

As shown in FIG. 9, on the one hand, prosthesis 1 is now in a precisely defined position on counter 25 due to the exact fit on impression 20, here by at least part of the occlusal surfaces 15, and on the other hand, also counter 25 itself is in a precisely defined position due to the exact fit of key structures 9, 11 or 21, 22 relative to blank 3. All in all, dental prosthesis 1 is thus in the exact position in which duplicate 7 of dental prosthesis 1 was produced on blank 3.

For further processing, according to a conceivable variant, counter 25 together with the reduced dental prosthesis temporarily fastened thereto in a suitable manner and the polymer material adhering thereto, i.e. the fixing agent 29, which however has no particular adherence to blank 3 here, can be lifted off blank 3 and positioned in a machine tool by means of reference key holder 19. The attachment of prosthesis 1 to counter 25 can e.g. be achieved by means of an adhesive (generally an adhesion-promoting substance) which is previously applied to at least part of the contact zones between impression 20 and prosthesis 1. With regard to the strength of the adhesion promotion, at least such an area is to be covered that the requirements of subsequent processing steps are met. In the simplest case, the entire contact surface of impression 20 is provided with adhesive. The adhesive is suitably selected so as to be dissolved, weakened (e.g. by heating) or otherwise made sufficiently ineffective or destroyed after processing that the prosthesis can be removed from counter 25 without being damaged. Subtractive machining of the bonding surfaces by the machine (grinding) is also possible.

It is conceivable to remove the adhesive by the action of a solvent, e.g. by immersion in a solvent. Another possibility is a strong temperature change, i.e. heating or also cooling, in a temperature range in which the adhesive at least partially loses cohesion or adhesive force or both.

Preferably, however, counter 25 is lifted off after fixing agent 29 has cured. Blank 3 with prosthesis 1 is fixed in the machine tool for machining in a manner known per se. Since prosthesis 1 is now located in a position within the machine tool of which the coordinates are known within the machine tool, machining of the gingiva imitation can be performed without damaging the prosthesis.

If, on the other hand, a change is to be made to the occlusal surfaces 15 of dental prosthesis 1, fixing agent 29 can be designed as a stable connection to blank 3 which can be subsequently released. Due to the above-mentioned precise positioning of all parts according to FIG. 9, the prosthesis is now also precisely positioned on blank 3 and can thus be accurately machined in a machine tool since the coordinates of the scan of the prosthesis according to FIG. 1 can be converted into the coordinates of the machine tool.

If the exact arrangement of counter 25 or blank 3 with prosthesis 1 in the machine tool is problematic, it is possible to attach them to the machine tool without exact positioning. If the nominal position of key structures 9,10 or 21, 22 in machine coordinates is not known or the key structures are not suitable for precise positioning, e.g. by scanning, machine reference marks 33 can be applied at predetermined positions, e.g. in the form of small holes. Afterwards, blank 3 or counter 25 is scanned. From the relative position of machine reference marks 33 and key structures 9, 10 or 21, 22, a mapping function of the design data to the machine coordinates can be created. As a result, it is thus possible to map the design data which were created using the scan of prosthesis 1 in FIG. 1 mentioned above, exactly to the real position of prosthesis 1 in the machine tool—prosthesis 1 is positioned in the carrier or counter 25 exactly at the position of the duplicate—and thus to precisely control the machine tool numerically for the intended machining operations on prosthesis 1.

### Second Exemplary Embodiment

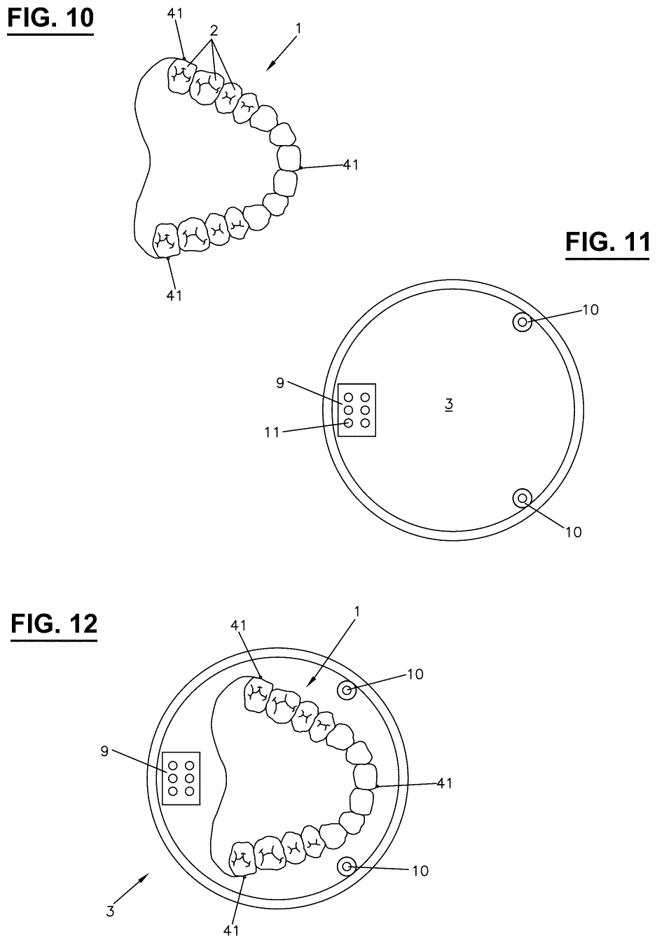

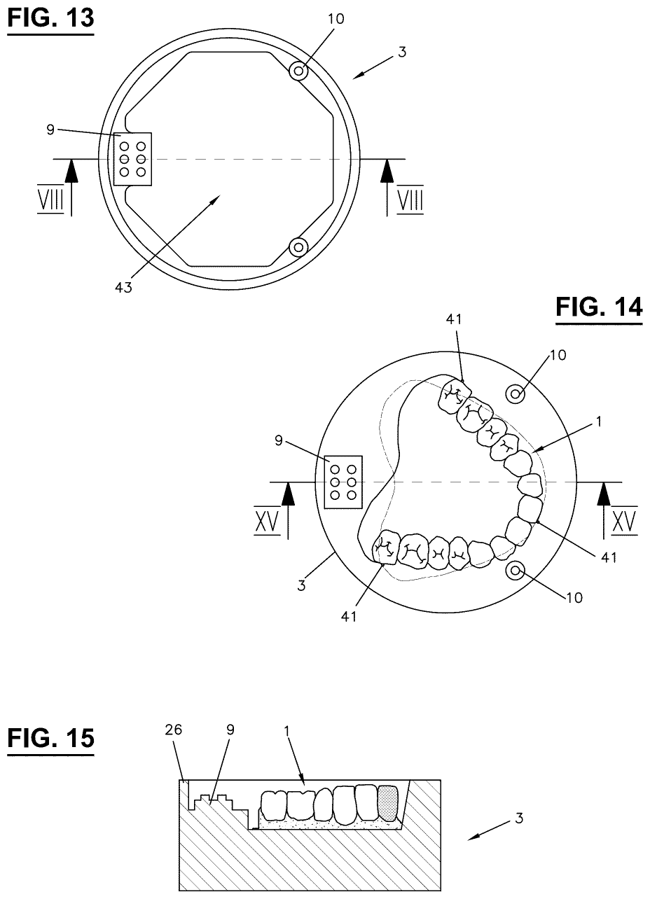

As shown in FIG. 10, referencing bodies 41 (here: beads) are bonded to prosthesis 1, for example by means of wax. For reasons of precision, referencing beads 41 are attached at points as far apart as possible, in the example at one of the anterior teeth and at the rearmost molars. Beads, i.e. small balls, have the advantage that they can be affixed in any position and provide the same image from all spatial directions. However, other small bodies that are easily recognizable and whose spatial position can be precisely determined are also conceivable. They should be large enough to still be easily recognizable, but on the other hand small enough to be easily affixed and not to interfere with the further steps. Preferred sizes (diameters) are in the range of few millimeters, e.g. 1 mm-5 mm, preferably 1 mm. As a material for the beads, or bodies in general, one may be considered that is easily scannable, i.e. provides clear contrast and sharp contours. Depending on the background, white or black is advisable, possibly also a color that forms a high contrast to the background. A matte surface is advantageous to suppress reflections from the surroundings.

The referencing beads 41 (or more generally referencing bodies or reference marks) must obviously be placed at sufficiently different locations (preferably as far apart as possible) that they can be distinguished, i.e. that the length and position of a line in space that connects the spheres can be determined with sufficient resolution. In general, additional beads must not lie on an already existing connection between two beads or, in the case of at least 4 beads, in a plane formed by three other beads. Therefore, in general, a basic set of reference marks consists of features none of which is part of a geometric object (line, polygon) defined by any subset of the other reference marks. However, it is conceivable to affix additional, actually redundant beads which serve to increase the measurement accuracy, e.g. by averaging, or as a safety in case one of the beads falls off.

It is conceivable to use a surface section of the prosthesis that is sufficiently characteristic to be recognized and precisely localized by image recognition methods as a reference mark.

Prosthesis 1 with reference beads 41 is scanned. Based on the scanned data, which allows creating a virtual duplicate, the required machining steps are determined in suitable design software such as a CAM system. Essentially, a virtual image (see FIG. 12) of blank 3 with prosthesis 1, i.e. the workpiece, and additionally of key structures 9, 10 as well as of reference bodies 41 is created. The machining steps are defined based on this image.

A blank 3 (FIG. 11) is provided with key structures 9, 10 in the machine tool. In contrast to the first embodiment, however, the key structures serve as machine reference marks for determining the position of the coordinate system of the machine tool, since they are formed at the locations corresponding to data specified by the CAM system. Preferred structures are those that are readily visible in a scan and allow high precision in determining the position. In addition to the shapes shown by way of example, which essentially correspond to those of the first example, such a machine reference mark can simply consist of a hole (diameter e.g. at most 5 mm, preferably at most 3 mm). Elevations may also be advantageous, e.g. conical or pyramidal ones, in which case the respective apex can be determined more precisely by cutting the flanks. For a better differentiation, arrangements or different types can be used, such as structure 9 in the figures, which is different from structures 10.

If necessary, blank 3 is provided with an exposed surface 43 on which dental prosthesis 1 can be placed (see FIG. 14).

Prosthesis 1 is attached to the blank as in the first embodiment, either in surface 43 or after the removal (e.g. by milling) of duplicate 7 as shown in FIG. 12.

Dental prosthesis 1 is attached to surface 43 in an upright position, as shown in FIG. 15, or alternatively with its underside facing upwards, depending on whether the top or the underside needs to be machined, or counter 25 is used as described above in order to be able to machine the underside.

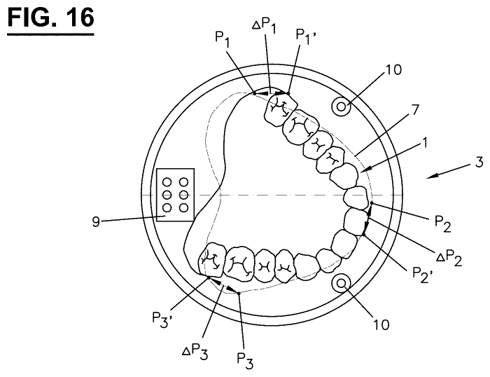

As shown in an exaggerated manner in FIG. 14, the position of the prosthesis on blank 3 will certainly not correspond, or at least not exactly enough, to the position according to the design (see FIG. 12), which is indicated in a broken line as the contour of duplicate 7. However, the position of prosthesis 1 on blank 3 can now be detected by a new scan, in particular of referencing beads 41. As shown in FIG. 16, the respective displacements ΔP1, ΔP2, ΔP3 of the construction points (here three, namely P1, P2 and P3) can now be determined in relation to the positions (P1′, P2′, P3′) measured on the real prosthesis 1. With the boundary condition that the size of the design, i.e. the position of points P1-P3 or P1′-P3′ relative to each other is identical, three points are sufficient to convert the design to the position of the real prosthesis according to 14.

This can be imagined schematically e.g. by the following procedure:
1. Point P1 is moved to P1′;
2. There follows a rotation around an axis through P1′ (is equal to P1), the axis of rotation being perpendicular to a triangle formed by P1′, P2, and P2′. This rotation turns point P2 to P2′ so that P2 equals P2′ after this operation;
3. A rotation follows around an axis through P1′ and P2′, whereby P3 is moved to P3′.

Changes perpendicular to the drawing plane, i.e. in reality to the surface of platform 5, are also taken into account—the position differences ΔP1, ΔP2, ΔP3 can therefore also contain a component perpendicular to the drawing plane.

Different scales while scanning prosthesis 1 according to FIG. 10 and prosthesis 1 on blank 3 according to FIG. 14 can be taken into account by determining the distances between the reference beads and setting them in relation to each other. In this respect it is assumed that the different scale applies in all spatial directions.

The aforementioned methods allow the required precision to be maintained at least for the finishing of dental prostheses. As a rule, they provide a determination of the processing coordinates with a tolerance of approx. 30 μm (0.03 mm) nowadays. A deviation of at most 0.5 mm can be regarded as the lower limit of processing accuracy; deviations of at most 0.2 mm and in particular 0.1 mm are better and more suitable for practical use.

An interesting application of this method in order to allow reworking a prosthesis or more generally a workpiece without damaging it, is its use in manufacturing. Particularly in additive machining processes (3D printing), there is a large price differential between machine tools that have the required final precision and those with unacceptably high tolerances. With the aid of the above method, it is conceivable to first manufacture a workpiece, in particular a dental or other model, by means of a machine tool of lower precision and corresponding oversize and then to finish the product in a machine tool, usually a machine tool of subtractive manufacturing such as a milling machine, whereby the exact position of the workpiece in the milling machine is determined by means of the present method.

The data processing steps in the preceding description are preferably performed in an automated manner on a computer or processor based on a program. In particular, this applies to the conversion of the scanned images to the representation of the CAM system and the conversion of the CAM data to the coordinate system of the real prosthesis or the real workpiece in the position it occupies in the blank and in the machine tool.

From the foregoing description of the exemplary embodiments, a wide variety of variations and complements are accessible to one skilled in the art without departing from the scope of protection of the invention, which is defined by the claims. Some conceivable variants are mentioned in the description of the exemplary embodiments.

It is also conceivable that:
The invention is applied to the finishing of workpieces of any kind.
The blank does not become part of the workpiece and thus exclusively serves as a base. It can therefore be made of a material that makes it more suitable as a workpiece holder in the machining process used.
The spacing of the key structures or machine reference marks is at least ⅓ of a largest diameter of the workpiece in projection onto the blank or base.
In methods prototypically represented by the second embodiment, in particular, one to all key structures are not formed spatially, but two-dimensionally or essentially one-dimensionally, e.g. printed structures such as color marks, line structures, geometric figures and mixed forms thereof. However, in methods analogous to the first exemplary embodiment, such key structures in the broader sense presumably require a higher effort in order to align the counter and the blank exactly to each other by means of the key structure by moving them relative to each other until the predetermined relative position of the key structures is reached.

1. A method for positioning a workpiece in preparation to machining in a numerically controlled machine tool, wherein
the workpiece is provided with a number of reference marks, and/or reference marks are selected from structures present on the workpiece which allow orientation and position of the workpiece to be determined at least in one plane,
the workpiece is attached to a base for machining,
the machine tool applies a number of key structures to the base in accordance with data in a construction coordinate system,
at least the reference marks and the key structures are scanned to obtain position data, and by means of the position data, the data in the coordinate system are converted by a computer under control of a program into data for controlling the machine tool, so that changes to the workpiece defined in the construction coordinate system can be made on the workpiece by the machine tool.

2. The method according to claim 1, wherein at least two reference marks arranged at distinguishable locations are applied to and/or selected on the workpiece.

3. The method according to claim 1, wherein each key structure consists of at least one of the following provisions:
a hole;
a cone;
a pyramid.

4. The method of claim 1, wherein the orientation and position of the workpiece are determined in space.

5. The method of claim 2, wherein the at least two marks comprise at least three marks.

6. The method of claim 5, wherein the at least three marks are arranged at distinguishable locations and are applied to the workpiece in the form of bodies.

7. The method of claim 5, wherein the at least three marks arranged at distinguishable locations are applied to the workpiece in the form of reference beads.

8. The method according to claim 3, wherein each key structure consists of at least one of the following provisions:
a hole of at most 5 mm;
a cone;
a pyramid.

9. The method according to claim 3, wherein each key structure consists of at least one of the following provisions:
a hole of at most 3 mm in diameter;
a cone;
a pyramid.

10. The method according to claim 6, wherein the workpiece is attached to the base by means of an adhesion-promoting material and the adhesion-promoting material is solidified to form a bond between the base and the workpiece.
